(19) United States
(12) Patent Application Publication
(10) Pub. No.: US 2009/0102648 A1
(43) Pub. Date: Apr. 23, 2009

(54) Motion detector

(75) Inventor: Ting-Hua LUNG, Taipei County (TW)

Correspondence Address: Joe McKinney Muncy, PO Box 1364, Fairfax, VA, 22038-1364, US

(73) Assignee: EVERSPRING INDUSTRY CO., LTD.

(21) Appl. No.: 11/976,059

(22) Filed: Oct. 19, 2007

(51) Int. Cl. G08B 13/00

(52) U.S. Cl. 340/541

(57) ABSTRACT

The invention discloses a motion detector that includes a casing, a sensor and a signal deflector. The casing has a lens array around an external periphery of the casing and an installation space inside the casing for installing the sensor and the signal deflector. The sensor includes a sensing unit and a signal processing unit electrically connected with each other. The signal deflector is installed between the sensor and the lens array, and the signal deflector includes a plurality of elliptic concave lenses for reflecting lights incident from different directions to the sensing unit by the focusing characteristics of the elliptic concave lenses, so as to broaden the scope of applications.

### FIELD OF THE INVENTION

The present invention relates to a motion detector, and more particularly to a motion detector for detecting a change of an external environment to turn on an electronic device such as a lamp or an alarm.

### BACKGROUND OF THE INVENTION

In general, a common electronic device used for detecting human bodies usually adopts a pyroelectric infrared sensor, and its specific characteristics are used for different applications, particularly for the use as a component of burglar alarms. If the sensor detects a change of the distribution of energy, the sensor will produce a signal to turn on a lamp or activate an alarm to achieve the burglarproof effect.

At present, a vast majority of products using passive infrared (PIR) to detect human bodies usually adopts a lens array made of a high density polyethylene (HDPE) material to focus the infrared rays emitted from a human body, and the focused infrared ray is reflected to a sensing area of a sensor by a signal deflector.

U.S. Pat. No. 5,103,346 entitled “Detector with 180 detecting range” discloses a signal deflector having several deflector surfaces, and such signal deflector has the shortcoming of a very limited sensing range. Since the angle of incidence of light varies, it is necessary to compute the position of a reflective point.

U.S. Pat. No. 6,653,635 provides a “Detector with wide detecting range” and discloses a signal deflector plate having a plurality of symmetric reflecting units, and the incident infrared ray is focused by a lens with a single focal length, and each path of the infrared rays includes S3, S4, S5 and S6, but these infrared rays are incident from the point Ec. Although the signal deflector can solve the problem of the angle of incidence, yet the centralized energy of the focused infrared cannot be maximized.

### SUMMARY OF THE INVENTION

The primary objective of the present invention is to provide a motion detector for increasing the detecting range of the detector, such that the detecting range can approach up to a level free of dead corners.

To achieve the foregoing objective, the present invention provides a motion detector, comprising: a casing, a sensor and a signal deflector, and the casing includes a lens array around the casing and an installation space inside the casing for installing the sensor and the signal deflector. The sensor includes a sensing unit and a signal processing unit electrically connected with each other. The signal deflector is installed between the sensor and the lens array, and the signal deflector includes a plurality of elliptic concave lenses for reflecting lights incident from different directions to the sensing unit, and a lamp or an alarm is turned on or off by a control of the signal processing unit, so as to achieve the effect of broadening the scope of applications.

### BRIEF DESCRIPTION OF THE DRAWINGS

FIG. 1 is a perspective view of a motion detector of the present invention;

FIG. 2 is an exploded view of a motion detector assembly of the present invention;

FIG. 3 is another exploded view of a motion detector assembly of the present invention;

FIG. 4 is a perspective of a motion detector and its signal deflector of the present invention; and

FIG. 5 is a schematic view of a light reflection of a motion detector in accordance with the present invention.

### DETAILED DESCRIPTION OF THE PREFERRED EMBODIMENTS

The technical contents of the present invention will now be described in more detail hereinafter with reference to the accompanying drawings that show various embodiments of the invention.

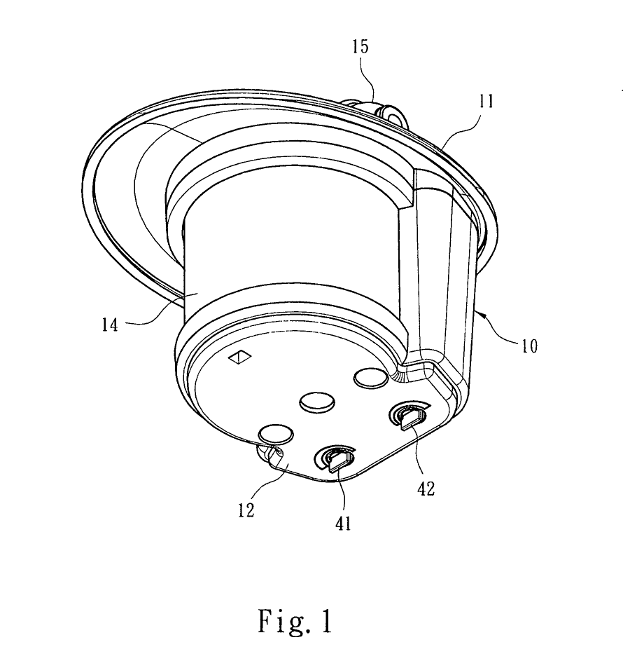

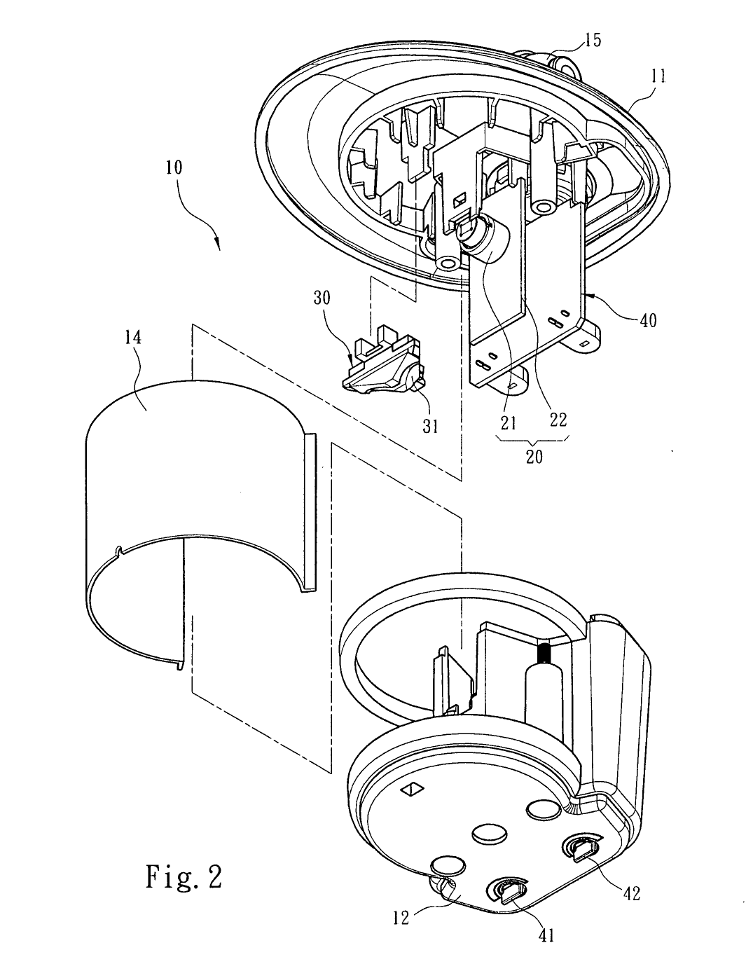

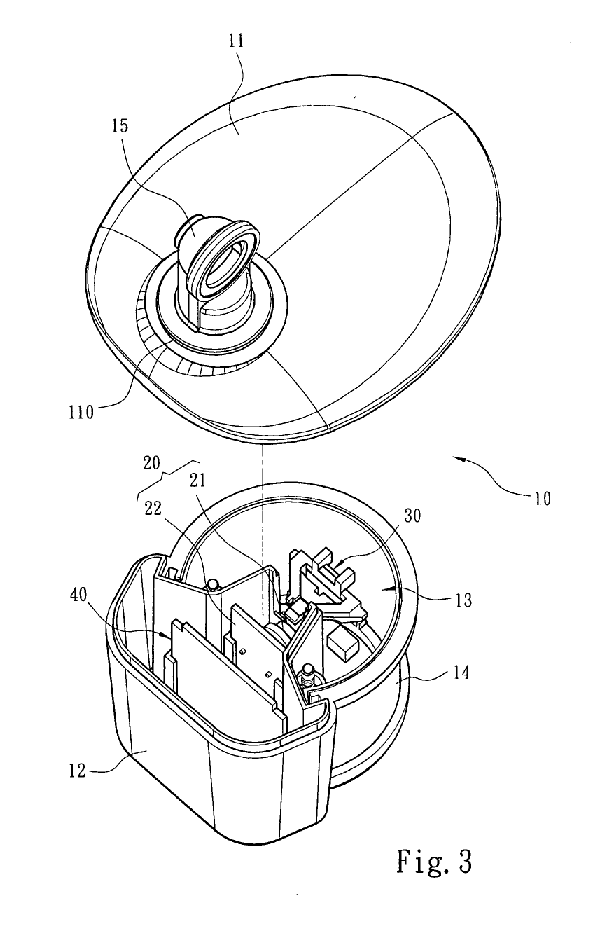

Referring to FIGS. 1 to 3 for a perspective view, and exploded views of a motion detector of the present invention respectively, the present invention detects a change of an external environment by an infrared light and drives a lamp to produce a light source or triggers an alarm to issue a warning to remind users about the detected change of the environment. As shown in the figures, the present invention comprises a casing 10, a sensor 20 and a signal deflector 30. The casing 10 includes an upper casing 11, a lower casing 12, and an installation space 13 inside the casing 10 for installing the sensor 20 and the signal deflector 30. The casing 10 further includes a lens array 14 disposed around an external periphery of the casing 10, and the lens array 14 is fixed to the lower casing 12. The sensor 20 includes a sensing unit 21 (such as an infrared sensor) and a signal processing unit 22 (such as a circuit board), wherein the sensing unit 21 is fixed at the signal processing unit 22 and electrically connected to the signal processing unit 22, and the signal processing unit 22 is fixed at the lower casing 12, and the lower casing 12 further includes a parameter setting unit 40 (such as a circuit board) electrically connected to the sensing unit 21, and the parameter setting unit 40 includes a time control button 41 and a brightness control button 42, both exposed from the casing 10, and the time control button 41 and the brightness control button 42 are used for adjusting the sensing time of a desired object and its brightness respectively. Further, the signal deflector 30 is fixed at the upper casing 11 and installed between the sensor 20 and the lens array 14, and the signal deflector 30 includes a plurality of elliptic concave lenses 31, and the upper casing 11 includes an opening 110 for inserting a hub 15, and the hub 15 is provided for accommodating a signal transmission line (not shown in the figures) of the signal processing unit 22 and connecting the signal transmission line to another electronic device (such as a lamp, an alarm and a speaker), and the hub 15 can be used for hanging the casing 10 at a position (such as a ceiling) above the detecting environment, so as to constitute a motion detector.

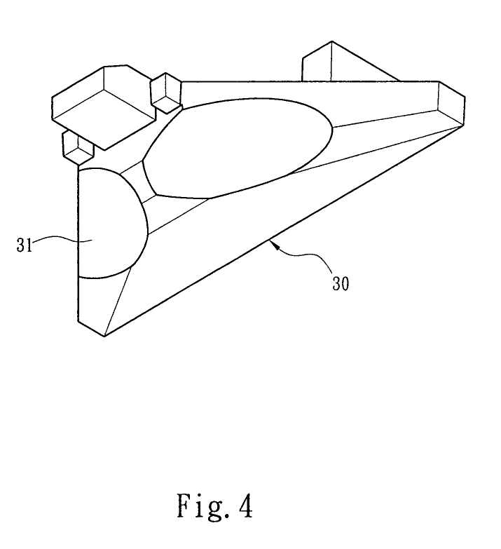

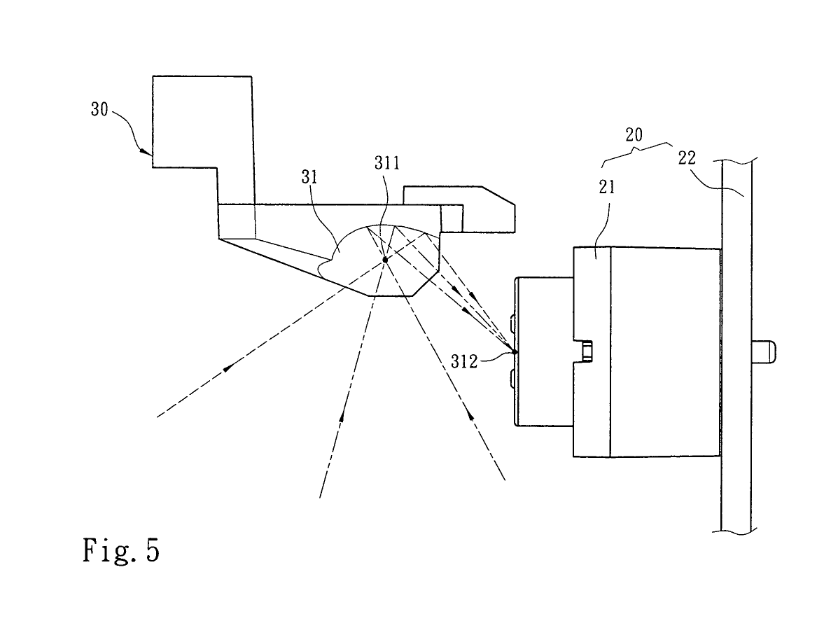

Referring to FIGS. 4 and 5 for a perspective of a signal deflector of a motion detector and a schematic view of its light reflection in accordance with the present invention, an incident light is passed through a lens array 14 (not shown in the figures) and projected onto the signal deflector 30, and the incident light passed through the lens array 14 (not shown in the figures) is focused at a first local point 311 of the elliptic concave lens 31, and the incident light focused at the focal point 311 is reflected from the elliptic concave lens 31 to a second focal point 312 of the sensing unit 21 disposed on the elliptic concave lens 31. After the sensing unit 21 receives the incident light, the signal processing unit 22 transmits the detected light in a form of electronic signal to an electronic device such as a lamp or an alarm to achieve the warning and reminding effects. With the focusing characteristics of dual focal points of the elliptic concave lenses 31, the signal deflector 30 can receive incident lights from different directions. Therefore, the present invention can have a broader scope of applications, as well as the following advantages:

1. The invention adopts the principle of an elliptic concave lens to improve the sensing range, greatly simplify the number of lenses in a traditional detector, and overcome the issue of having dead corners on the reflection of a plane mirror.

2. Since the sensing range of the invention is broader, the number of detectors used for sensing an environment can be reduced to lower the installation costs.

3. The invention can be used together with an electronic device such a lamp or an alarm to provide diversified applications.

While the invention has been described by means of specific embodiments, numerous modifications and variations could be made thereto by those skilled in the art without departing from the scope and spirit of the invention set forth in the claims.

What is claimed is:

1. A motion detector, for detecting a change of an external environment to turn on an electronic device including a lamp or an alarm to remind users of the change of environment, and the motion detector comprising:
a casing, having an installation space therein, and a lens array disposed around the external periphery of the casing;
a sensor, installed in the installation space, and including a sensing unit and a signal processing unit electrically coupled to each other;
a signal deflector, installed in the installation space, and disposed between the sensor and the lens array, and having a plurality of elliptic concave lenses.

2. The motion detector of claim 1, wherein the sensing unit is fixed to the signal processing unit.

3. The motion detector of claim 1, wherein the signal processing unit is a circuit board.

4. The motion detector of claim 1, wherein the sensing unit is an infrared sensor.

5. The motion detector of claim 1, wherein the casing comprises an upper casing and a lower casing.

6. The motion detector of claim 5, wherein the upper casing includes an opening for inserting a hub.

7. The motion detector of claim 5, wherein the lower casing includes a parameter setting unit electrically coupled to the signal processing unit.

8. The motion detector of claim 7, wherein the parameter setting unit includes a time control button and a brightness control button, both exposed from the casing.

9. The motion detector of claim 7, wherein the parameter setting unit is a circuit board.
